(19) United States
(12) Patent Application Publication
(10) Pub. No.: US 2013/0290908 A1
(43) Pub. Date: Oct. 31, 2013

(54) SYSTEMS AND METHODS FOR CREATING AND UTILIZING HIGH VISUAL ASPECT RATIO VIRTUAL ENVIRONMENTS

(71) Applicants: Matthew Joseph Macura, Loveland, OH (US); Greg Lee Konya, Lawrenceburg, IN (US); Jan Cord, Crailsheim (DE); Steve Joseph Waas, Mason, OH (US); Michael Wayne Taylor, JR., Springdale, OH (US)

(72) Inventors: Matthew Joseph Macura, Loveland, OH (US); Greg Lee Konya, Lawrenceburg, IN (US); Jan Cord, Crailsheim (DE); Steve Joseph Waas, Mason, OH (US); Michael Wayne Taylor, JR., Springdale, OH (US)

(21) Appl. No.: 13/456,973

(22) Filed: Apr. 26, 2012

(51) Int. Cl. G06F 3/048

(52) U.S. Cl. 715/850

(57) ABSTRACT

An interactive virtual method for manufacturing plant construction, planning, design, touring, and/or management, the method comprising: providing a user with a first interactive, virtual environment comprising facility information and equipment information; proposing a question; and navigating the environment to obtain answers to the proposed questions; wherein said method is a computer-based environment comprising a high visual aspect ratio and wherein said method does not employ computer-aided design.

Additionally, a method for creating a high visual aspect ratio virtual tour, comprising: collecting a plurality of first images of areas of low detail and a plurality of second images of areas of high detail; stitching the first images together to create a plurality of first spherical-format images and the second images together to create a plurality of second spherical-format images; combining the first spherical-format images with the second spherical-format images to create a high visual aspect ratio virtual tour.

### FIELD OF THE INVENTION

The present application relates generally to creating and utilizing high visual aspect ratio virtual environments and specifically to creating and utilizing high visual aspect ratio virtual environments of manufacturing facilities and equipment to enable construction, planning, design, touring, management, or the like.

### BACKGROUND OF THE INVENTION

It is common practice within many industries for workers to physically visit different sites, whether for training, audits, project work, equipment installation, sales calls, etc. For instance, in the manufacturing industry, it is quite common for engineers of a particular company to travel to their own company's manufacturing sites as well as to the sites of business partners' manufacturing sites. A main reason for this travel is to personally see manufacturing equipment. Many engineers will visit a site to gather information before heading back to their home site. This information may include photographs of a manufacturing plant or equipment, measurements, machine gauge readings, or the like. This is an expensive, inefficient, and slow means of gathering information. For example, an engineer may travel to a site to take a series of two-dimensional (2D) photographs to thereby record equipment details and information. Yet, 2D photographs even a series of them are neither interactive nor easy to navigate through. While the 2D photographs may serve as a good reminder for the engineer, now home, who traveled to the site and took the photographs, it is hard for another engineer who has not been to the site to follow or grasp the layout of a plant, the equipment details, etc. This single-layer-of-detail approach of working from 2D photographs is far inferior to working from an in-person, multiple-layers-of-detail approach. And, as the marketplace becomes more and more competitive and individuals and companies continue to try to reduce costs, this method of information gathering is not always practical. Thus, there exists a need to quickly gather remote information without incurring all of the expenses of physical travel. In addition, there is a need to gather this remote information quickly and easily. There is also a desire for a user-friendly virtual system that enables users to gather multiple-layers-of-detail information about the macro-details of a facility (e.g., the layout of a facility and the equipment therein) and also gather information about the micro-details of a facility or piece of equipment (e.g., the dial on a specific piece of equipment).

Three-dimensional (3D) simulations of spaces are principally constructed with computer-aided design (CAD) software. These simulations may be used for many different applications, e.g., general visualization, real estate, video games, operations planning, etc. Being CAD based, objects must be generated in a CAD format, which can be time consuming, expensive, and difficult for very complex systems and buildings. There is much rework when something within the environment changes. The expense of using a CAD-based simulation system could be as much as or even more than the expense of actual physical travel.

Further, simulations typically rely on positioning features like global position systems, markers, telemetry, 3D tracking devices, orientation sensors, and the like. These features may be part of the initial physical environment or they may be placed appropriately therein. Then, 3D models of an environment may be created based upon the cumulative information collected by the positioning features. Drawbacks to this approach are that it is time-intensive, requires a lot of equipment, and is hard to update and keep current.

Another way of producing 3D simulations is by using a panoramic camera which provides 360° visual information from a single point. This method requires equipment such as a panoramic lens and complex software. This allows a user to simulate standing in one location and turning 360° to see the environment around him However, this type of simulation does not provide multi-directional walking, turning, and zooming functionality. Alternatively, laser scanning of as-build equipment and installations is possible. While laser scanning is often cheaper and faster than creating full 3D CAD models for complex systems, laser scanning is still relatively slow and expensive compared to digital photography. Furthermore, these existing systems do not sufficiently provide access to both high-level detail and low-level detail simultaneously. Accordingly, it is advantageous to provide a system and method for creating and utilizing a high visual-aspect-ratio virtual environment.

There is a need for a virtual environment that can be quickly, easily, and inexpensively created and updated. There is a need for a virtual environment which may be easily navigated and which provides multi-directional walking, turning, and zooming functionality. There is a need for a virtual environment that simultaneously provides low detail and high detail.

These are all goals of the present invention; embodiments described herein may achieve various combinations of these goals. A particular embodiment may, but need not, embody every goal.

### SUMMARY OF THE INVENTION

An interactive virtual method for manufacturing plant construction, planning, design, touring, and/or management, the method comprising: providing a user with a first interactive, virtual environment, the virtual environment comprising facility information as well as equipment information; proposing a question regarding the equipment, the facility, or combinations thereof; and navigating the virtual environment to obtain answers to the proposed questions; wherein said method is a computer-based virtual environment comprising a high visual aspect ratio and wherein said method does not employ computer-aided design.

Additionally, a method for creating a high visual aspect ratio virtual tour, comprising: collecting a plurality of first images of areas of low detail; collecting a plurality of second images of areas of high detail; stitching the plurality of first images together to create a plurality of first spherical-format images; stitching the plurality of second images together to create a plurality of second spherical-format images; combining the first spherical-format images with the second spherical-format images to create a high visual aspect ratio virtual tour; and publishing the tour to a display-based input/output unit to enable users to access the tour.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

It is to be understood that both the foregoing general description and the following detailed description describe various systems and methods and are intended to provide an overview or framework for understanding the nature and character of the claimed subject matter. The accompanying drawings are included to provide a further understanding of the various systems and methods, and are incorporated into and constitute a part of this specification. The drawings illustrate various systems and methods described herein, and together with the description serve to explain the principles and operations of the claimed subject matter.

FIG. 1 depicts a method for creating a high visual aspect ratio virtual tour described herein;

FIG. 2 depicts a block diagram of the imaging system;

FIG. 3 depicts an information input device in the form of a camera;

FIG. 4 depicts a computing device according to systems and methods disclosed herein;

FIG. 5 depicts a floorplan map according to systems and methods disclosed herein;

FIG. 6 depicts a screen shot of a virtual environment of an area of low detail;

FIG. 7 depicts a screen shot of a virtual environment of an area of high detail;

FIG. 8 depicts a screen shot of a virtual environment being used for design purposes; and

FIG. 9 depicts a flowchart of an interactive virtual method for manufacturing plant construction, planning, design, touring, and/or management according to systems and methods disclosed herein.

### DETAILED DESCRIPTION OF THE INVENTION

The systems and methods described herein may be used to create virtual environments based upon actual/real outdoor or indoor environments or objects. The present invention provides a method of producing an interactive, virtual environment that comprises a high visual aspect ratio.

There are many benefits of employing the systems and methods described herein. People may virtually travel to any facility, anywhere in the world. This enables faster, better-informed decision-making, for instance, regarding capacity and manufacturing construction planning Additionally, project teams may benefit from improved design by better understanding installed layouts and avoiding late surprises during construction and rollouts. Also, operators, engineers, and new employees may have better access to more interactive technical transfer of equipment designs, installation requirements, operation, safety, and training.

The systems and methods enable the testing/visualization of real or virtual equipment in a virtual environment. Business continuity may be promoted by visually archiving facilities undergoing changes, remodeling, or the like. Further, new capacity could be executed more cost-effectively and with flawless construction planning including adding new equipment, line relocation to a new site, or line duplication to an additional site.

To enable these benefits, we have made key advancements in work processes and tour technologies to understand and resolve a contradiction of traditional virtual simulation technologies. A major revelation was the need to photograph large spaces, such as an entire plant floor (which can be 100 m×100 m or larger), while also photographing sufficient detail to be able to read dials and see equipment intricacies (which can be on a 0.01 m scale). The marrying of these macro-details and micro-details within one virtual environment is a key advancement. Surprisingly, these “high visual aspect ratio” virtual environments are simple, inexpensive, and quick to create. These new systems and methods include the ability to navigate through and interact with a virtual environment of a facility as well as the associated equipment.

The virtual environments employed are non-CAD based; that is, the virtual environments are not created with CAD software. Rather, a virtual environment is created by capturing images (e.g., photographs) of an actual environment and stitching them together.

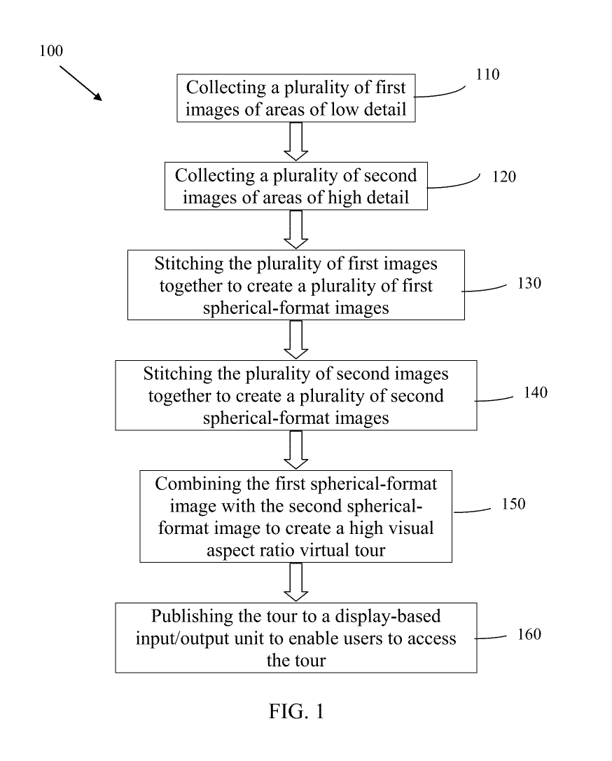

Referring now to the drawings, FIG. 1 shows a method 100 for creating a high visual aspect ratio virtual tour. The method comprises collecting a plurality of first images of areas of low detail 110; collecting a plurality of second images of areas of high detail 120; stitching the plurality of first images together to create a plurality of first spherical-format images 130; stitching the plurality of second images together to create a plurality of second spherical-format images 140; combining the first spherical-format images with the second spherical-format images to create a high visual aspect ratio virtual tour 150; and publishing the tour to a display-based input/output unit to enable users to access the tour 160.

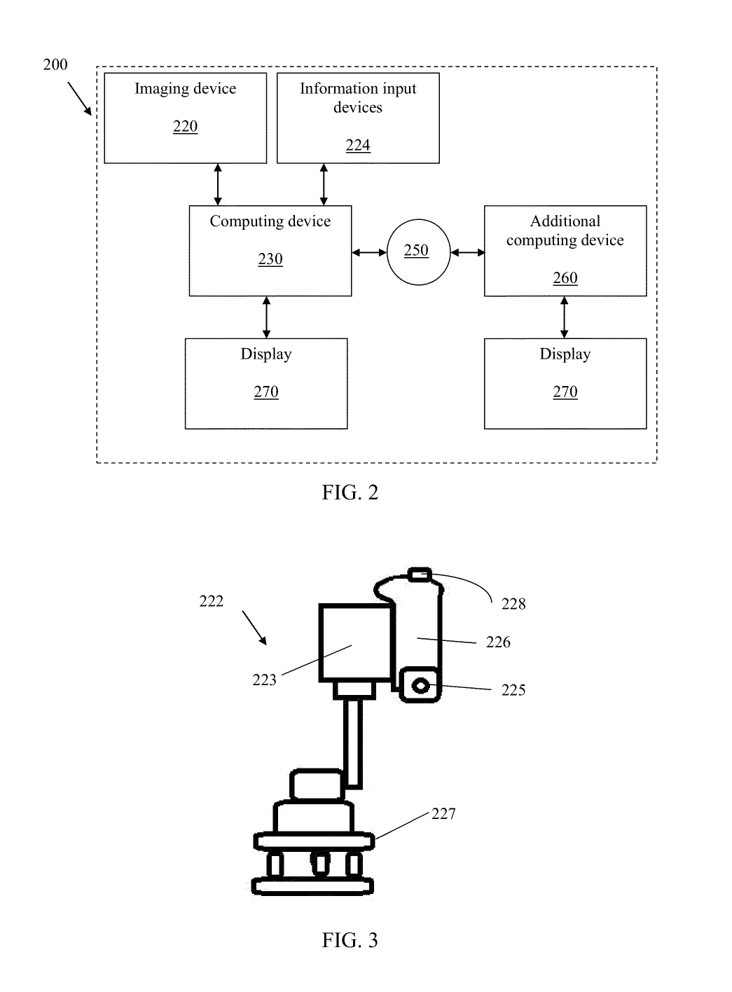

FIG. 2 shows an imaging system of the present invention is shown generally at 200. The imaging system 200 can be used to create and utilize high visual aspect ratio virtual environments. The imaging system 200 comprises an imaging device 220, information input devices 224, a computing device 230 (for creating and utilizing a virtual environment), a network server 250, at least one additional computing device 260 (for utilizing a virtual environment), and at least one display 270.

Preferably, the imaging device 220 is a camera 222. The camera 222 may be monocular, panoramic, pan-tilt-zoom, etc. The camera 222 may be mounted on a tripod, a pan-and-tilt unit, manufacturing equipment, a vehicle, or the like. Suitably, the camera is not hand-held, as this can reduce the precision of the images taken. Suitably, the camera 222 is mounted on a tripod. A suitable camera 222, like the one shown in FIG. 3, comprises a Nikon D7000 camera body 223, a Sigma fisheye lens 225, a Nodal Ninja Ultimate R10 lens mount 226, and a tripod 227 to position the camera's focal point at eye-level, roughly six feet off the ground. The lens mount provides 90 degree rotation about the focal point of the image with a fish eye lens.

The number of imaging devices 220 required is one or more. When only one camera 222 is used, the method involves obtaining a plurality of images (e.g., taking a plurality of photographs). The camera 222 may be moved around to different locations within the actual environment. When two or more cameras 222 are used, they may be placed in a particular spatial relationship to one another and calibrated accordingly.

In place of or in addition to the camera 222, the imaging system 200 may comprise at least one information input device 224. The information input device 224 may be mounted on the camera 222 or may be separate from the camera 222. Information input devices 224 comprise video cameras, sensors, scanners (e.g., to digitize photos previously taken), or other imaging or location/measurement devices. Or, sensors may include a gyro sensor, geomagnetism sensor, radiation detector, light sensor, smoke sensor, dust/particulate sensor, temperature sensor, or the like. The imaging system 200 may comprise a camera 222 as well as a sensor 228.

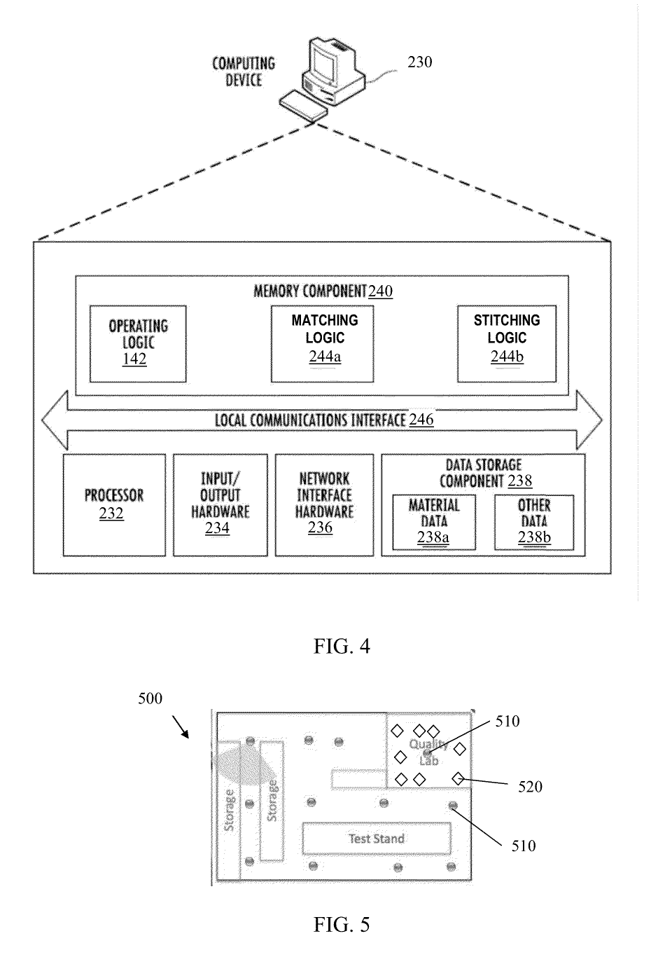

FIG. 4 depicts a computing device 230 for creating and utilizing a virtual environment, according to systems and methods disclosed herein. In the illustrated environment, the computing device 230 includes a processor 232, input/output hardware 234, network interface hardware 236, a data storage component 238 (which stores image data 238a and other data 238b), and a memory component 240. The computing devices 230,260 may comprise a desktop computer, a laptop computer, a tablet computer, a mobile phone, or the like.

The memory component 240 of the computing device 230 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular configuration, these non-transitory computer-readable mediums may reside within the computing device 230 and/or external to the computing device 230.

Additionally, the memory component 240 may be configured to store operating logic 242, matching logic 244a, and stitching logic 244b, each of which may be embodied as a computer program, firmware, and/or hardware, as an example. A local communications interface 246 is also included in FIG. 4 and may be implemented as a bus or other interface to facilitate communication among the components of the computing device 230.

The processor 232 may include any processing component operable to receive and execute instructions (such as from the data storage component 238 and/or memory component 240). The input/output hardware 234 may include and/or be configured to interface with a monitor, keyboard, mouse, printer, camera, microphone, speaker, and/or other device for receiving, sending, and/or presenting data. The network interface hardware 236 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 230 and other computing devices.

Similarly, it should be understood that the data storage component 238 may reside local to and/or remote from the computing device 230 and may be configured to store one or more pieces of data for access by the computing device 230 and/or other components. In some systems and methods, the data storage component 238 may be located remotely from the computing device 230 and thus accessible via a network. Or, the data storage component 238 may merely be a peripheral device external to the computing device 230.

Included in the memory component 240 are the operating logic 242, the matching logic 244a and the stitching logic 244b. The operating logic 242 may include an operating system, web hosting logic, and/or other software for managing components of the computing device 230. Similarly, the matching logic 244a may be configured to cause the computing device 230 to collect and register, or match, adjacent images. Additionally, the stitching logic 244b may reside in the memory component 240 and may be configured to cause the processor 232 to stitch together the images, based on the suggested matching, to create the spherical images as described in more detail below.

It should be understood that the computing device 230 components illustrated in FIG. 4 are merely exemplary and are not intended to limit the scope of this disclosure. While the components in FIG. 4 are illustrated as residing within the computing device 230, this is merely an example. In some systems and methods, one or more of the components may reside external to the computing device 230. It should also be understood that, while the computing device 230 in FIG. 4 is illustrated as a single system, this is also merely an example. In some systems and methods, the modeling functionality is implemented separately from the prediction functionality, which may be implemented with separate hardware, software, and/or firmware.

Referring back to FIG. 1, one or more displays 270 are used for creating and/or utilizing a virtual environment according to systems and methods disclosed herein. The display 270 may comprise a desktop computer monitor, a laptop computer screen, whiteboard, television, projector, an immersive environment (e.g., a cave), a tablet computer screen, a mobile phone screen, or the like.

Turning back to how the virtual environment is created, a floorplan map or image of equipment, a building, or at least a portion of a facility is presented. The floorplan map relates to the area of interest to be made into a virtual environment. The floorplan map can come from a 2D drawing, a 3D drawing, a sketch, a picture, or a variety of other places. The floorplan map is ideally to scale, but might also be illustrative or artistic, and meant to convey the general proximity of items within the area of interest. FIG. 5 shows an exemplary floorplan map 500.

Locations on the floorplan map 500 are marked as locations corresponding to the physical environment at which images will be taken and used to create a virtual environment. To capture the total environment and high level location of items relative to each other in the environment, a first set of locations 510 are marked. Often, these are at large spacing between locations. For example, a manufacturing facility that might by 60 m long by 30 m across, these first set of marks might be at spacing of 3-5m apart around the outside perimeter, and along any walkways of interest through the middle of the manufacturing facility.

Next, a second set of marks 520 are made on the floorplan map 500. Particular areas of interest within the overall area of interest, such as equipment and workshops, often require many more picture locations to capture details. Often, an area of interest is identified. In this area, marks are made in a grid in and/or around an object, with a much tighter spacing of 0.5-1.5 m spacing. These areas often have more equipment, materials, data, and such that could be of interest in an interactive environment. Each mark on the floorplan map 500 again corresponds to a location in the physical environment at which images will be taken.

While it is possible to create a virtual interactive environment from just the first set of marks, often, the spacing in areas of great interest lack the details to answer many questions that may be of interest to users in the future.

It is also possible to just mark the entire area at a very high density to ensure all details are captured regardless of location. In this case, it takes significantly longer to photograph the entire area at this higher density, and longer to execute the remainder of the method required to create the virtual interactive environment. Navigating this resulting virtual environment is also a burden to the user, as in areas of relatively low interest, the higher point density requires more time and interaction to navigate through, and reach an area of particular interest at that point in time.

This two-step planning process has been found to best balance the effort required to generate and navigate a tour, while still providing the details required for high visual aspect ratio environments such as when a user may need to navigate a 60 m long by 30 m wide area, and gather data for a question related to optimal location of a gauge, located 0.5 m from a piece of equipment of interest and 0.1 m in size.

Having marked the floorplan map 500, the corresponding locations in the physical environment at which images to be taken are now known, and the images at each location can be captured, transferred, stitched (if needed), uploaded, linked, dots put on the floorplan map in the system, tour created, and presented to a user.

At a location, four images are taken at 90 degree angle rotating about a single point. After loading these images to a computing device 230, the images can be stitched together to create a single image using software such as AutoDesk Stitcher (Autodesk, San Rafael, Calif.) or PTGUI (New House Internet Services B.V., Rotterdam, The Netherlands), and rendered out from the stitching software to create a single, so-called spherical jpeg image at that point, ideally with a resolution of 6000 by 3000 pixels. Stitching can be done manually, by a user interactively, or can be scripted by one skilled in the art to execute more efficiently. In an alternative embodiment, a panoramic camera or lens could be used to capture a single image at a point that would encompass the full 360 degrees. EyeSee360 Inc. (Pittsburgh, Pa.) is one such company that offers a range of lenses for different cameras able to create 360 degree images from a single location, such as the GoPano Micro that could be used with an iPhone 4s (Apple, Cupertino, Calif.) to create a 360 degree image at a location directly, using a photo warper such as PhotoWarp (EyeSee360 Inc in Pittsburgh, Pa.) to directly create the 360 degree without stitching. The additional control and precision in taking the multiple images and stitching them together produces a higher quality final image, while requiring only a minimal amount of additional effort. The new method is much faster & quicker to generate (than CAD methods) while still providing the ability to interact and navigate through the visual environment. Creating the visual environment as disclosed herein takes from 10% to 99% less time than it would take to create such an environment using CAD software. For example, for a 3m wide mixing tank, it may take 1 hour whereas CAD may take 10-40 hours, depending on the complexity of the impeller, mounting, ancillary equipment, and number of parts. In addition to being less arduous, the virtual environment described herein is also cheaper than CAD-based approaches.

While spherical images may be generated from a series of images taken with a digital camera in a physical location, it is also possible to generate images from within a virtual environment that might not exist physically. Such environments could be created from CAD, in animation software, from scanning software, and perhaps a combination and result in creating a 3 dimensions set of points and or surfaces that can be rendered within a computer. In one such embodiment, a surface file in a stereolithography file format is generated from a CAD file that has been created for an entire building that is being designed, including the equipment to be located in the building. This stereolithography file is read into animation software such as 3ds Max from Autodesk in San Rafael, Calif. Lighting and shading can be added to provide a more visually realistic appearance, and by using cameras at prescribed locations in the 3D file, spherical jpeg images can be directly rendered to a preferred 6000×3000 pixel aspect ratio. The camera locations inside the imported stereolithography file can be defined to be in the same locations relative to the areas of interests as was used for a physical environment. Likewise, a floorplan image of the imported stereolithography file can be generated, and the method of creating an interactive virtual environment from the series of at least one or more spherical jpeg images and floorplan image can be the same as has been prescribed to create a virtual environment from a physical location. While the 3 dimensional set of points and or surfaces can itself be navigated by a user directly, often the file format, software requirement, and memory requirements required to quickly access and interact with the environment can provide limitations to users. In creating the interactive virtual environment as described in this method, often more users can quickly access and interact with the resulting virtual environment.

The virtual environment of the present invention requires less photos and less stitching than previous construction planning methods. Yet, at the same time, the virtual environment simultaneously provides low detail (e.g., of macro objects) and high detail (e.g., of micro objects). Areas of low detail are selected from manufacturing facilities, buildings, warehouses, distribution centers, office buildings, laboratories, testing facilities, fabrication facilities, rooms, hallways, aisles, compounds, complexes, yards, grounds, campuses, or the like, and combinations thereof. Areas of high detail are selected from equipment, materials, tools, people, guarding, computers, instructions, controls, products, packaging, measurement apparatuses, and the like, and combinations thereof. The systems and methods allow a user to move, pan, and zoom through the environments vs. having strictly a temporal freedom.

The computing device 230 is connected to network interface hardware 236 to allow remote connectivity from at least one or more other computing devices 260 that are connected to the same network. On the computing devices 230,260 VPIX Voyager 360 is installed (available from Virtual Pictures Corporation, Monument, Colo.). Installation and set-up of this software on the computing devices 230,260 can be readily performed by one skilled in the art with the assistance of the documentation and customer support provided by Virtual Pictures Corporation. With VPIX Voyager 360 installed, using a web browser such as Mozilla Firefox or Google Chrome, one can connect to the computing device 260 to interact with the VPIX Voyager 360 software for purposes of creating an interactive virtual environment for many users at remote sites.

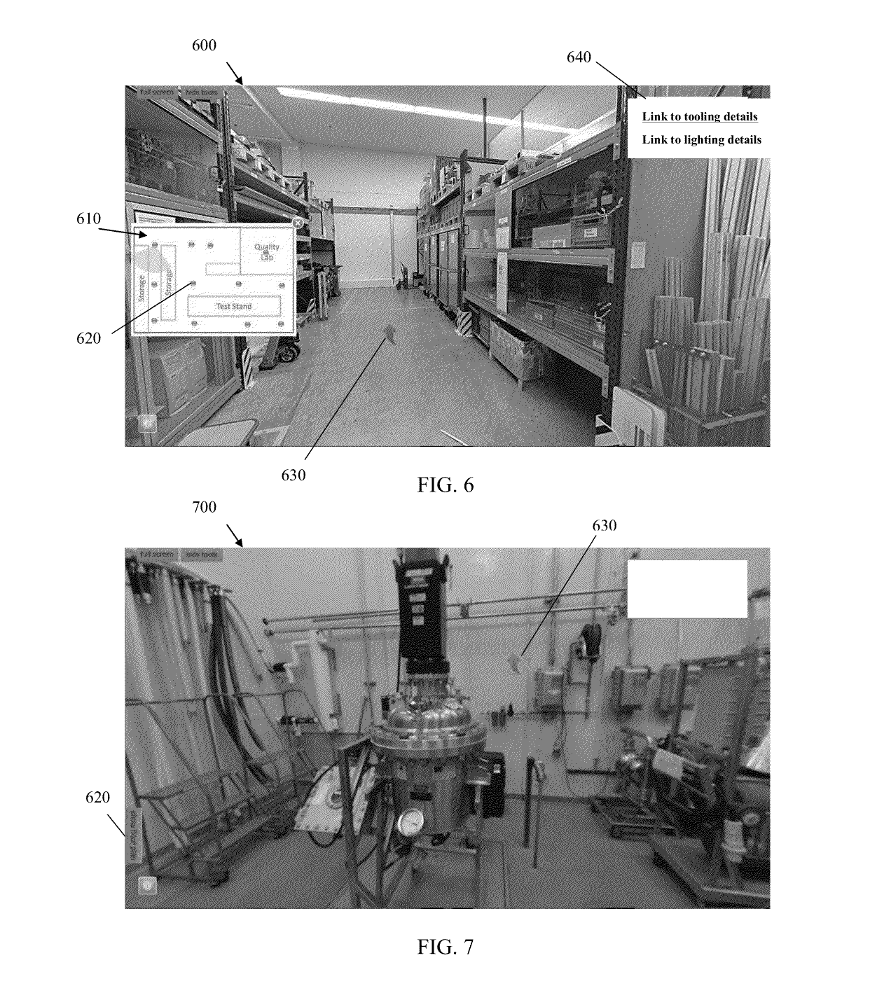

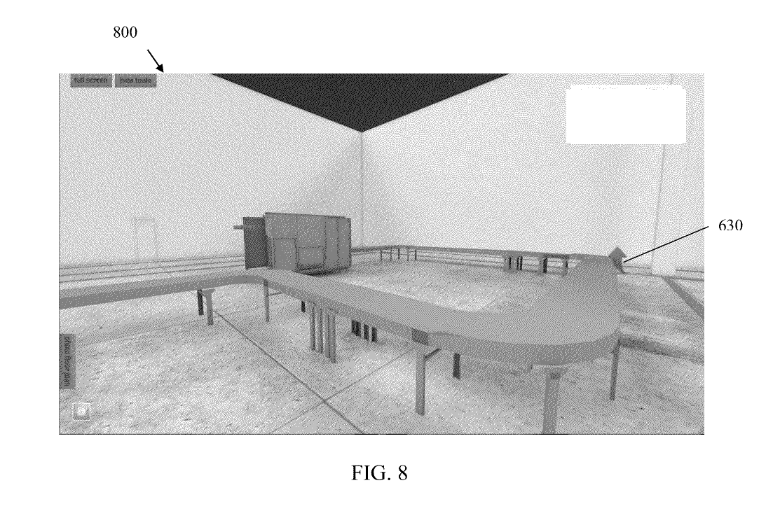

Once the spherical jpeg images are created for each point of interest, each of these images is loaded, across the network, onto the computing device 230 in the VPIX Voyager 360 software. FIG. 6 depicts a screen shot of a virtual environment 600 of an area of low detail. FIG. 7 depicts a screen shot of a virtual environment 700 of an area of high detail. FIG. 8 depicts a screen shot of a virtual environment 800 being used for design purposes.

The floorplan map 500 (which is often a 2D, top down digital drawing or sketch in a jpeg or png file format) is loaded onto the computing device 230 to create a virtual floorplan 610 correlating to the environment to be created. The floorplan 610 relates directly to the locations 510,520 and at least portion of a facility in which the photographs were taken and subsequently stitched into spherical jpeg images.

For at least a portion of the spherical jpeg images, in the VPIX Voyager 360 software, the location is marked on the floorplan 610 using a dot 620 to represent that location using the functionality of marking the position on the floorplan 610. On the floorplan 610, the dot 620 is placed in the same position relative to the floorplan 610 as the image was taken relative to that portion of the facility. In doing so for at least a portion of the images, a relative physical position for each image can be later provided to a user of the system to understand the relative location of each image taken within the portion of the facility. Ideally, each spherical jpeg image loaded on the computing device 230 would be represented by a dot 620 on the floorplan 610. For very large tours that maybe have 60 or more spherical jpeg images that often have locations with a high density of images, a user may choose to include only a portion of the spherical jpeg images with dots 620 on the floorplan 610 to provide a more simplified visual appearance.

For at least a portion of the spherical jpeg images, in the VPIX Voyager 360 software, hot links 630 can be created to move between dots 620 in the floorplan 610, or, other pertinent information links 640 can be associated with the floorplan 610. Within an image, a user will identify a location in that particular image, select an icon from a selection of existing or user uploaded icon images, and select either a different spherical jpeg within that tour being created, or provide a web address to other pertinent information that can be accessed through the network to which the computers are connected. Ideally, within the image, the so-called hot links 630 to other images or links to pertinent information 640 are placed in the same relative position in the image as they would be for a person physically standing in the location at which the image or images were taken. Within the software, to the end user, this creates additional context to more seamlessly move from location to location, when interacting with the environment, as one would interact with the real environment as if they were there.

The virtual environment is typically a historical simulation, meaning that it is not based upon a live feed or updated real-time. However, at various spots throughout the virtual environment, there may be links which, when clicked, will take the user to a live feed of that particular spot. Pertinent information that can be linked includes, but is not limited to, drawings, traditional digital pictures, CAD files, movie files, schedules, documents (e.g., operational documents, material safety data sheets, instructions, manuals, etc.), spreadsheets, computer based models, databases, and web cameras (e.g., for live feed).

The systems and methods described herein comprise at least one virtual environment. Preferably, a plurality of virtual environments is accessible by a user of the system. The systems and methods herein may comprise geo-mapping capabilities. For instance, Google Maps or the like may be utilized as a plug-in to view coordinate-based locations for the virtual environments. Thus, each virtual environment may be associated and/or identified by a specific longitude and latitude. A plurality of virtual environments depicting locations in various places around the globe may be shown and accessed from a user-friendly map on the web site. Specifically, a map may be present on the web site that comprises names of locations or symbols such as push-pins, flags, icons, or the like in the appropriate positions on the map. Users may click on the names or signals to be directed to the corresponding virtual environment. The virtual method may comprise one virtual, interactive environment from one location or multiple virtual, interactive environments from multiple locations worldwide, such as at least 2 locations, at least 10 locations, at least 30 locations, at least 60 locations, or at least 100 or more locations. This may be helpful for a company having many manufacturing plants. Or, it could be applicable to companies such as Starbucks, Subway, or Wal-Mart such that they can plan, build, archive, and easily view store set-ups.

Upon completing these steps, one may select options such as logos to appear, navigation controls, appearance, among other such visual options that can be displayed in the end environment. Finally, the tour is created, and in doing so, a web address is generated that can be provided to other individuals that have the ability to connect their computing device 260 to this computing device 230 through the network server 250 connection, and this web address may be used in browsers such a Google Chrome, Mozilla Firefox, and Microsoft Internet Explorer to directly access this resulting virtual environment. Optionally, one may choose on the system to require that a specific user account is required to access this virtual environment, in which after providing the web address to the browser, the user is presented with a screen that requires an authenticated user name and corresponding password be presented before being allowed to access the visual environment. This user account and password is preferably created directly in the VPIX Voyager 360 software using the same access and interface required to build the tour in which a user name, password, and tour access can be created by one have access to the administrative portions of the computing device 230. Alternatively, one could use .htaccess in the Apache web computing device 230 software to alternatively require authentication either to the entire computing device 230 or to specific web addresses, such as the virtual environments generated on the computing device 230. Through the act of installing and setting up the VPIX Voyager 360 software, the user also installs the Apache web computing device 230 software that can provide this functionality at a more basic computer system level.

Once the tour has been created, one with administrative access to the VPIX Voyager 360 software has the ability to return to the tour of interest, and either update or modify any of the above instructions and information within the tour. Upon completion of these changes, the tour can again be created, and in doing so, the same web address as previously is retained, and the now changed tour is provided to users. Accordingly, it is possible to correct, modify, or add information to the tour, including adding additional spherical images and locations if so desired.

One skilled in the art would recognize that while our preferred embodiment is executed using VPIX Voyager 360 software, other software could be used for such purposes, such as software provided Real Tour Vision of Traverse City, Mich., or Tourweaver from Easypano Holdings Incorporated of Shanghai, China.

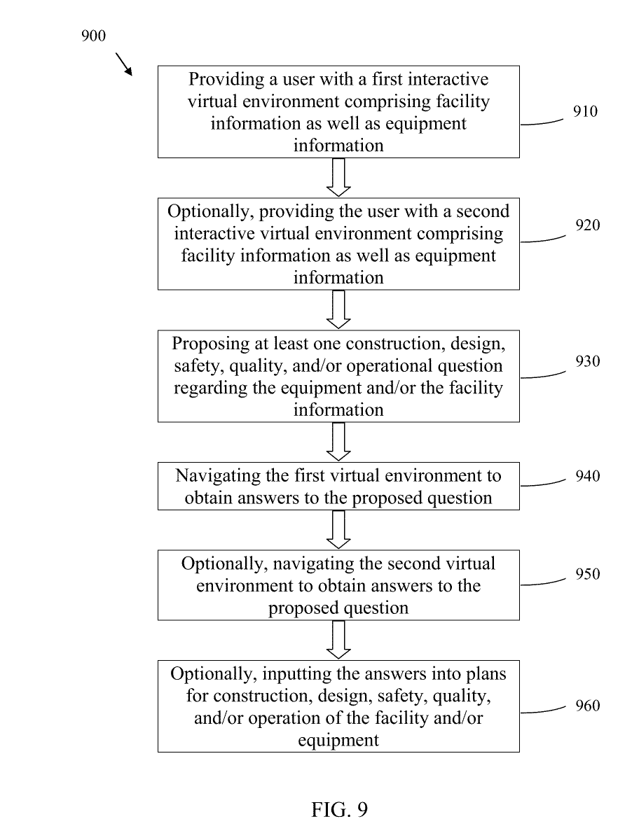

FIG. 9 depicts a flowchart of an interactive virtual method for manufacturing plant construction, planning, design, touring, and/or management according to systems and methods disclosed herein. The method comprises the steps of providing a user with a first interactive virtual environment comprising facility information as well as equipment information 910; optionally, providing the user with a second interactive virtual environment comprising facility information as well as equipment information 920; proposing at least one construction, design, safety, quality, and/or operational question regarding the equipment and/or the facility information 930; navigating the first virtual environment to obtain answers to the proposed question 940; optionally, navigating the second virtual environment to obtain answers to the proposed question 950; and optionally, inputting the answers into plans for construction, design, safety, quality, and/or operation of the facility and/or equipment 960.

Upon building and creating the virtual environment, the virtual environment can be accessed by a user interested in accessing the tours for better understanding or planning purposes, and can connect to the computing device 230 through the network using a web browser such as Microsoft Internet Explorer. In a preferred embodiment, the user has at least one question they desire to have answered prior to accessing the virtual environment. The user can interact with the environment, which includes the ability to jump from spot to spot (either using the dots 620 on the floorplan 610, or by using the hot links 630 to different locations created within at least a portion of the images), rotate within the image at a location, zoom in and out within an image, and access other pertinent information 640 that may be linked to an image. In interacting with the virtual environment, the user is able to gain additional information required to answer the question. Examples of such questions that may be useful include, but are not limited to: “Where are the controls mounted relative to a piece of equipment?” “How much open space is there in a particular part of a building?” “Would that open space be sufficient to fit a 10×10×3 m piece of equipment?” “What kind of safety guarding does the equipment have?”

Often, the virtual environment the user interacts with is created from a physical environment in a different location than were the user physically resides or is located. This provides the benefit of virtually traveling to that other location, avoiding the significant time and cost required for traveling. In some cases, it is desired to compare a piece of equipment located in one location, with a piece of equipment or facility in a different location. This is often true when in the process of planning for construction required to install a piece of manufacturing equipment. It is also often true that the engineering design, fabrication, initial testing, and final installation for a piece of equipment are performed in different locations. In these such cases, it is of high benefit when a user can also be an engineer working to design a piece of equipment, has the ability to access and interact with a first virtual environment related to the equipment being fabricated and or tested, and a second environment related to the location in a facility for final installation. In such a case, the use can interact with both the first and second environment, and answer questions related to the transport and installation of the equipment in the facility, such as “What kind of facility connections are required?” “How to best transport the equipment within the facility to the final location?” “How much disassembly is required of the equipment prior to transportation?”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular systems and methods of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. An interactive virtual method for manufacturing plant construction, planning, design, touring, and/or management, the method comprising:
providing a user with a first interactive, virtual environment, the virtual environment comprising facility information as well as equipment information;
proposing a question regarding the equipment, the facility, or combinations thereof; and
navigating the virtual environment to obtain answers to the proposed questions;
wherein said method is a computer-based virtual environment comprising a high visual aspect ratio and wherein said method does not employ computer-aided design.

2. The method of claim 1, wherein the method further comprises inputting the resulting answers into the plans for construction, design, or the like of the facility and/or equipment.

3. The method of claim 1, wherein the virtual environment is published to an intranet or internet web site.

4. The method of claim 1, wherein the method further comprises providing the user with a second interactive, virtual environment.

5. The method of claim 1, wherein the method further comprises providing the user with a map comprising links to multiple interactive, virtual environments.

6. The method of claim 1, wherein the method further comprises providing the user with a map comprising links to at least ten interactive, virtual environments.

7. The method of claim 1, wherein the virtual environment comprises links to other pertinent information.

8. The method of claim 7, wherein the other pertinent information is selected from drawings, traditional digital pictures, CAD files, movie files, schedules, documents, spreadsheets, computer based models, databases, web cameras, and combinations thereof.

9. The method of claim 1, wherein the virtual environment comprises at least one floorplan.

10. The method of claim 9, wherein the virtual environment comprises at least one dot in each floorplan.

11. The method of claim 10, wherein the virtual environment comprises at least one hot link to move to another dot in the floorplan.

12. A method for creating a high visual aspect ratio virtual tour, comprising:
collecting a plurality of first images of areas of low detail;
collecting a plurality of second images of areas of high detail;
stitching the plurality of first images together to create a plurality of first spherical-format images;
stitching the plurality of second images together to create a plurality of second spherical-format images;
combining the first spherical-format images with the second spherical-format images to create a high visual aspect ratio virtual tour; and
publishing the tour to a display-based input/output unit to enable users to access the tour.

13. The method of claim 12, wherein areas of low detail are selected from manufacturing facilities, buildings, warehouses, distribution centers, office buildings, laboratories, testing facilities, fabrication facilities, rooms, hallways, aisles, production line, compounds, complexes, yards, grounds, campuses, and combinations thereof.

14. The method of claim 12, wherein areas of high detail are selected from equipment, materials, tools, people, guarding, computers, instructions, controls, products, packaging, measurement apparatuses, and combinations thereof.

15. The method of claim 12, wherein collecting images comprises taking photographs.

16. The method of claim 12, wherein the method further comprises planning shot spacing before collecting a plurality of first images.

17. The method of claim 12, wherein the method further comprises planning shot spacing before collecting a plurality of second images.

18. The method of claim 12, wherein the tour is published to an intranet or internet web site.

19. The method of claim 12, wherein collecting images comprises rendering images from a virtual, 3D environment.
